(19) United States
(12) Patent Application Publication
(10) Pub. No.: US 2014/0007947 A1
(43) Pub. Date: Jan. 9, 2014

(54) PIG LAUNCH AND RETRIEVAL SYSTEM

(71) Applicant: Orlande Sivacoe, Lacombe (CA)

(72) Inventor: Orlande Sivacoe, Lacombe (CA)

(21) Appl. No.: 13/541,717

(22) Filed: Jul. 4, 2012

(51) Int. Cl. B08B 9/055

(52) U.S. Cl. CPC B08B 9/055
USPC 137/15.07

(57) ABSTRACT

A method of launching a pig into and retrieving a pig from a path in tubing, for example through a furnace, by directing fluid flow into the path through the pig launcher/retriever during launch and fluid flow out of the path through the pig launcher/retriever during retrieval.

### TECHNICAL FIELD

Pigging Tubes

### BACKGROUND

It is known to use pigs in furnaces, including when the furnaces are online, see for example U.S. Pat. No. 6,569,255, which is incorporated by reference, by the same inventor. However, an improved launch and retrieval of a pig was desired over the system disclosed in U.S. Pat. No. 6,569,255.

### SUMMARY

There is disclosed a method of retrieving a pig in a flow system having an inlet, an outlet, a pig catcher, an intermediate section through which the pig travels, and a first flow path from a downstream end of the intermediate section to the outlet, the first flow path not passing through the pig catcher, by opening a second flow path from the downstream end of the intermediate section to the outlet, the second flow path passing through the pig catcher, restricting flow on the first flow path to force the pig into the second flow path, and retrieving the pig in the pig catcher as it enters the pig catcher on the second flow path.

In various embodiments, there may be included any one or more of the following features: the restriction of flow on the first flow path may be a complete stopping of flow. The first flow path may be restricted when the pig approaches the end of the intermediate area. The restriction to the first flow path may be ended once the pig enters the second flow path. The restriction to the first flow path may be ended once the pig is retrieved. The second flow path may be opened when the pig approaches the end of the intermediate area. The second flow path may be closed once the pig is retrieved. The pig catcher may be a pig catcher/launcher.

There is disclosed a method of launching and retrieving a pig in a flow system having an inlet, an outlet, a pig catcher/launcher, an intermediate section through which the pig travels, a first flow path from a downstream end of the intermediate section to the outlet, the first flow path not passing through the pig catcher/launcher, and a third flow path from the inlet to an upstream end of the intermediate section, the third flow path not passing through the pig catcher/launcher, by opening a fourth flow path from the inlet to the upstream end of the intermediate section, the fourth flow path passing through the pig catcher/launcher, restricting flow on the third flow path to force fluid to flow on the fourth flow path to launch the pig, removing the restriction to flow on the third flow path after the pig is launched, closing the fourth flow path, opening a second flow path from the downstream end of the intermediate section to the outlet, the second flow path passing through the pig catcher/launcher, restricting flow on the first flow path to force the pig into the second flow path, and retrieving the pig in the pig retriever as it enters the pig catcher/launcher on the second flow path.

In various embodiments, there may be included any one or more of the following features: the restriction of flow on the third flow path may be a complete stopping of flow. The restriction of flow on the first flow path may be a complete stopping of flow. The first flow path may be restricted when the pig approaches the end of the intermediate area. The restriction to the first flow path may be ended once the pig enters the second flow path. The restriction to the first flow path may be ended once the pig is retrieved. The second flow path may be opened when the pig approaches the end of the intermediate area. The second flow path may be closed once the pig is retrieved.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a drawing in schematic form of an embodiment of an apparatus for online pigging of a furnace;

FIG. 2 is a drawing in schematic form of the apparatus of FIG. 1 in normal operation with no pig deployed;

FIG. 3 is a drawing in schematic form of the apparatus of FIG. 1 when launching a pig; and

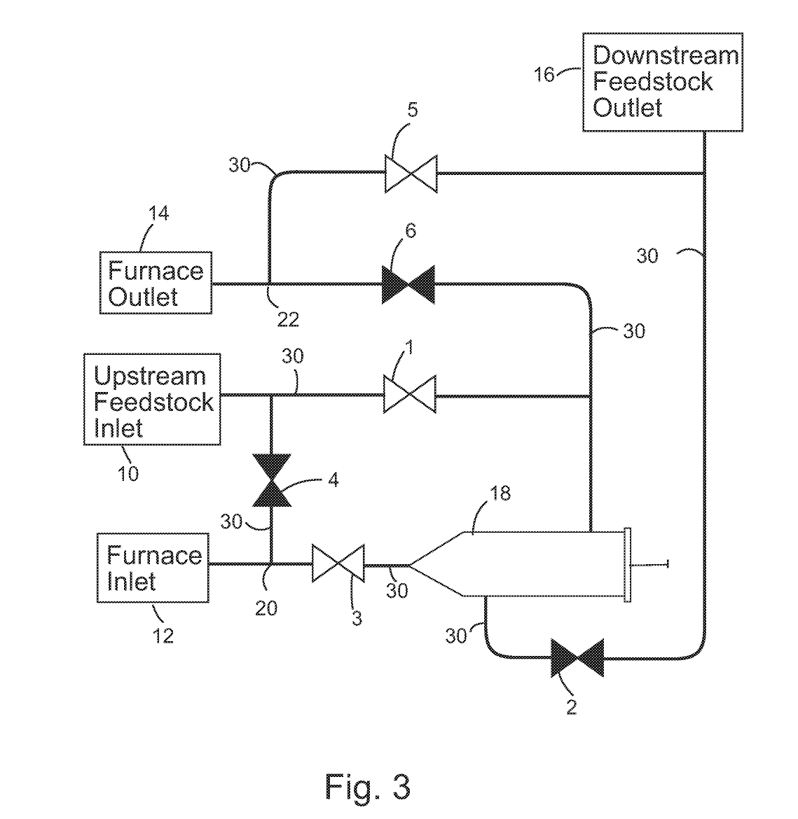

FIG. 4 is a drawing in schematic form of the apparatus of FIG. 1 when retrieving a pig.

### DETAILED DESCRIPTION

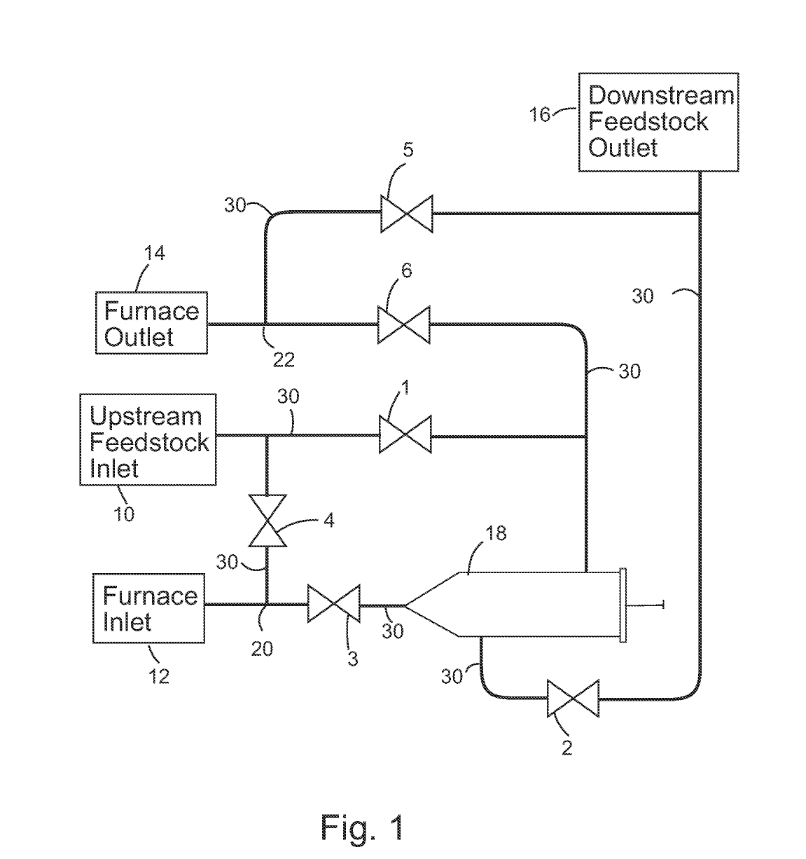

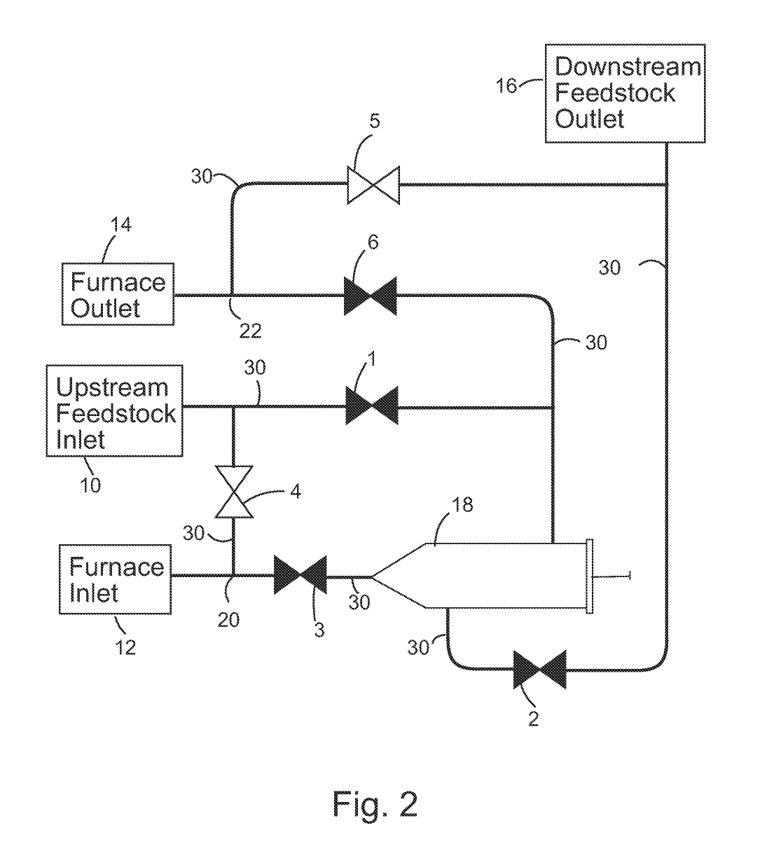

FIG. 1 is a drawing in schematic form of an embodiment of an apparatus for online pigging of a furnace. Fluid flows through the apparatus via tubes 30 from the upstream feedstock inlet 10, to furnace inlet 12, through the furnace (not shown), and from furnace outlet 14 to downstream feed stock outlet 16. The fluid flow is directed by means of valves 1-6. In normal operation with no pig deployed, valve 1 is closed, valve 2 is closed, valve 3 is closed, valve is 4 open, valve is 5 open, and valve 6 is closed. This allows fluid flow from the upstream feedstock inlet 10, to furnace inlet 12, through the furnace (not shown), and from furnace outlet 14 to downstream feed stock outlet 16 while isolating the pig launcher/retriever 18. FIG. 2 shows the apparatus of FIG. 1 in this state. When it is desired to launch a pig (not shown), first a pig is inserted into the pig launcher/retriever 18 (if not already present) and the opening (not shown) through which the pig is inserted into the pig launcher/retriever 18 from the outside is sealed. If the pig launcher/retriever 18 is not already filled with fluid, valve 1 is then opened to allow fluid to flow into the pig launcher/retriever 18. Valve 1 may be a variable flow control valve and may be opened partially to allow the fluid to enter the pig launcher/retriever 18 slowly. Pig launcher/retriever 18 may have a vent (not shown) to allow air to escape as it is filled with fluid. Then, valve 1 is opened if not already open and valve 3 is opened to allow the fluid to flow through the pig launcher/retriever 18 to the furnace inlet 12. If valve 1 is in a partially open state, valve 1 may be opened more fully. To ensure that the pig launches successfully, valve 4 is closed to force fluid flow to occur on the path through the pig launcher/retriever 18. FIG. 2 shows the apparatus of FIG. 1 in this launching state. Optionally, valve 4 can be reopened when the pig passes junction 20 as detected by a sensor (not shown) or assumed due to the passage of time. Valve 1 and valve 3 can then be closed. If valve 4 is reopened and valves 1 and 3 closed, then a drain valve (not shown) can optionally be opened in order to allow fluid to drain from the launcher after the pig is launched.

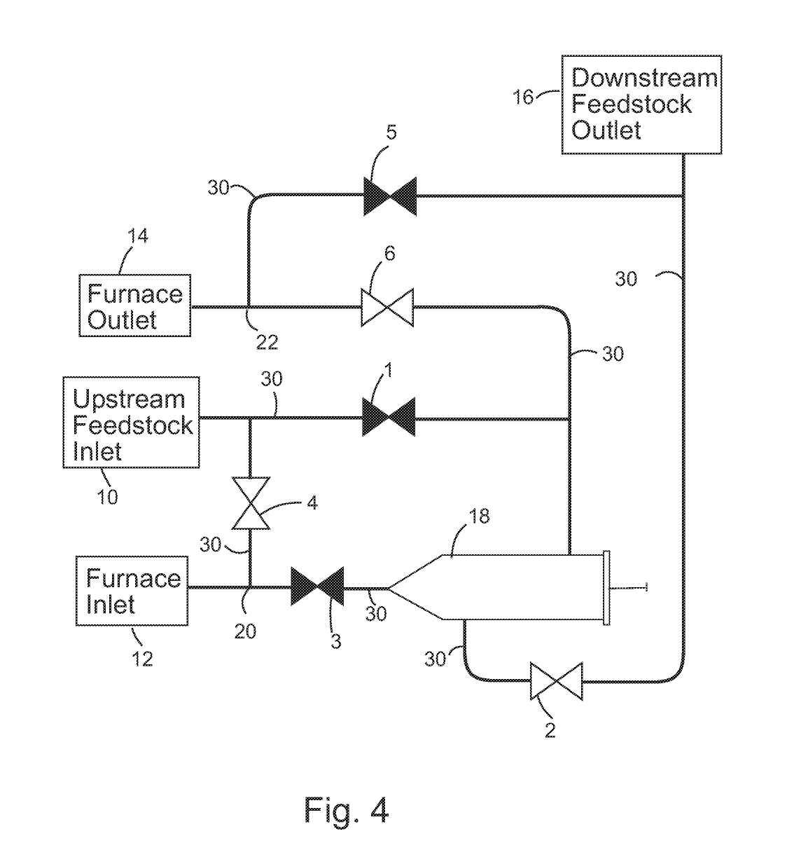

Before the pig reaches junction 22, but after the pig has past junction 20, as detected by a sensor or assumed based on the passage of time, valve 4 is opened if not already open, and valves 1 and 3 closed if not already closed. If the pig launcher/retriever 18 is not already filled with fluid, valve 6 is then opened to allow fluid to flow into the pig launcher/retriever 18. Valve 6 may be a variable flow control valve and may be opened partially to allow the fluid to enter the pig launcher/retriever 18 slowly. Pig launcher/retriever 18 may have a vent (not shown) to allow air to escape as it is filled with fluid. Then, valve 6 is opened if not already open and valve 2 is opened to allow the fluid to flow through the pig launcher to the downstream feedstock outlet 16. If valve 6 is in a partially open state, valve 6 may be opened more fully. To ensure that the pig travels on the correct route at junction 22, valve 5 may be closed to force fluid flow to occur on the path through the pig launcher/retriever 18. FIG. 4 shows the apparatus of FIG. 1 in this retrieving state. Valve 5 can be reopened when the pig has passed junction 22 or when the pig has been retrieved. Once valve 5 is reopened and the pig has returned to the pig launcher/retriever 18, valve 6 and valve 2 may be closed. If it is desired to re-launch the pig immediately, valves 1 and 3 can then be opened. If it is desired to remove the pig from the pig launcher/retriever 18, a drain valve (not shown) may be opened to remove fluid from the pig launcher/retriever 18 and once the pig launcher/retriever 18 is empty it may be opened to remove the pig.

Immaterial modifications may be made to the embodiments described here without departing from what is covered by the claims. In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

The embodiments of the invention in which an exclusive property or privilege is claimed are defined as follows:

1. A method of retrieving a pig in a flow system having an inlet, an outlet, a pig catcher, an intermediate section through which the pig travels, and a first flow path from a downstream end of the intermediate section to the outlet, the first flow path not passing through the pig catcher, the method comprising the steps of:
opening a second flow path from the downstream end of the intermediate section to the outlet, the second flow path passing through the pig catcher;
restricting flow on the first flow path to force the pig into the second flow path; and
retrieving the pig in the pig catcher as it enters the pig catcher on the second flow path.

2. The method of claim 1 in which the restriction of flow on the first flow path is a complete stopping of flow.

3. The method of claim 1 in which the first flow path is restricted when the pig approaches the end of the intermediate area.

4. The method of claim 1 in which the restriction to the first flow path is ended once the pig enters the second flow path.

5. The method of claim 1 in which the restriction to the first flow path is ended once the pig is retrieved.

6. The method of claim 1 in which the second flow path is opened when the pig approaches the end of the intermediate area.

7. The method of claim 1 in which the second flow path is closed once the pig is retrieved.

8. The method of claim 1 in which the pig catcher is a pig catcher/launcher.

9. A method of launching and retrieving a pig in a flow system having an inlet, an outlet, a pig catcher/launcher, an intermediate section through which the pig travels, a first flow path from a downstream end of the intermediate section to the outlet, the first flow path not passing through the pig catcher/launcher, and a third flow path from the inlet to an upstream end of the intermediate section, the third flow path not passing through the pig catcher/launcher, the method comprising the steps of:
opening a fourth flow path from the inlet to the upstream end of the intermediate section, the fourth flow path passing through the pig catcher/launcher;
restricting flow on the third flow path to force fluid to flow on the fourth flow path to launch the pig;
removing the restriction to flow on the third flow path after the pig is launched;
closing the fourth flow path;
opening a second flow path from the downstream end of the intermediate section to the outlet, the second flow path passing through the pig catcher/launcher;
restricting flow on the first flow path to force the pig into the second flow path; and
retrieving the pig in the pig retriever as it enters the pig catcher/launcher on the second flow path.

10. The method of claim 9 in which the restriction of flow on the third flow path is a complete stopping of flow.

11. The method of claim 9 in which the restriction of flow on the first flow path is a complete stopping of flow.

12. The method of claim 9 in which the first flow path is restricted when the pig approaches the end of the intermediate area.

13. The method of claim 9 in which the restriction to the first flow path is ended once the pig enters the second flow path.

14. The method of claim 9 in which the restriction to the first flow path is ended once the pig is retrieved.

15. The method of claim 9 in which the second flow path is opened when the pig approaches the end of the intermediate area.

16. The method of claim 9 in which the second flow path is closed once the pig is retrieved.
